(19) United States
(12) Patent Application Publication
(10) Pub. No.: US 2024/0005230 A1
(43) Pub. Date: Jan. 4, 2024

(54) A SYSTEM AND METHOD FOR RECOMMENDING EXPERT REVIEWERS FOR PERFORMING QUALITY ASSESSMENT OF AN ELECTRONIC WORK

(71) Applicant: INTELLIGENT REVIEW TECHNOLOGIES INC., Toronto (CA)

(72) Inventors: John Cuzzola, Kamloops (CA); Jelena Jovanovic, Belgrade (RS); Ebrahim Bagheri, 25 Burleigh Heights Drive (CA)

(21) Appl. No.: 18/255,345

(22) PCT Filed: Dec. 3, 2021
(86) PCT No.: PCT/CA2021/051735

§ 371 Date: May 31, 2023

Related U.S. Application Data
(60) Provisional application No. 63/120,804, filed on Dec. 3, 2020.

(51) Int. Cl. G06Q 10/0631; G06F 40/279

(52) U.S. Cl. CPC G06Q 10/063112; G06F 40/279

(57) ABSTRACT

Various embodiments are described herein for a system and method for automatically creating electronic expert reviewer profiles from individuals' electronic portfolio documents that represents their professional contribution history (e.g., publications, grant applications, presentations, patents, and/or resumes). The electronic expert reviewer profiles may be used to recommend the suitable experts to evaluate the quality of a particular work, in a manner that fully meets one or more requirements for such pairings such as subject matter competence, for example. Such recommendations have a multitude of impactful applications such as, but not limited to, finding reviewers for a research paper, forming an experts team to collaborate on a project, and/or finding evaluators for the assessment of grant applications.

### CROSS-REFERENCE

This application claims the benefit of U.S. Provisional Patent Application No. 63/120,804, filed Dec. 3, 2020, and the entire contents of U.S. Provisional Patent Application No. 63/120,804 is hereby incorporated by reference.

### FIELD

Various embodiments are described herein for a system and method for recommending expert reviewers for performing quality assessment of a work.

### BACKGROUND

The quality and trustworthiness of scientific artifacts are guaranteed by the critical evaluation of the reported findings, which is done through a peer review process. The process begins with a submission of an original artifact to a review panel. Having received a new submission, an editor or a referee committee has to assign the artifact to multiple reviewers who are subject matter experts suitable to evaluate the submission. Thus obtained evaluations are combined and ultimately used to make the decision on whether the submission meets the quality standards, requires revisions, or is not acceptable at all. The substantial effort required of the committee to match submissions to qualified reviewers, combined with the volume and frequency of submissions, often results in non-optimal pairings which can lead to the rejection of high quality submissions or the acceptance of weaker ones.

To select adequate reviewers for a particular submission, a referee committee needs to familiarize itself with the submission, primarily its subject area, topics, methods, and claimed contributions. This is typically done by examining the submission's title, abstract, and/or author supplied descriptors (keywords and/or taxonomy entries). Thus gathered information is used to search for a set of reviewers who would be best qualified to provide high quality and fair assessment of the submission. To handle this reviewer search task effectively, committee members have to: (a) be adept in the specific subject matter of the submission and (b) have an intimate familiarity with their reviewer pool, including the body of work, competences, and skills of individual reviewers. In addition, to assure fairness, no reviewer should be assigned to a submission for which they have a conflict of interest. Furthermore, since reviews are typically done on a voluntary basis, with no or very little explicit recognition for the completed work, the referee committee also needs to account for the interests of candidate reviewers, to increase the chance that an invited reviewer would accept the review invitation. Finally, in each field, and especially in the rapidly expanding ones, there is a need for a continuous expansion of the reviewer pool, which would prevent research cliques and assure extension of the research topics. All of these requirements make the reviewer search and selection process complex, difficult and time consuming.

Faced with these difficulties, the research community has developed different mechanisms aimed at facilitating the task of pairing submissions with appropriate reviewers. Among these, bidding and keyword-based matching are the most widespread, though each with its own shortcomings.

Bidding is typically used when submissions need to be assigned to a group of experts who have volunteered to be peer reviewers. It consists of asking candidate reviewers, from the volunteer group, to bid which involves expressing their preference for submissions they want to review (based on the submission's title, abstract, and/or keywords). So, for each submission, reviewers can say if they would like to review it, would be fine with reviewing it, or would not like to review it. After the bidding is over, the expressed preferences are used to assign submissions to the volunteers. While this process allows for finding reviewers with the required expertise and interest in the submissions they would like to review, this bidding process has important weaknesses. In particular, only a small proportion of potential reviewers are willing to perform the bidding process and even when they engage in the bidding process they do it only partially, getting discouraged by the sheer volume of the submissions. In addition, submissions on “popular” topics tend to receive many bids, whereas submissions on less-popular topics get very little or none.

Keyword-based matching consists of associating submissions to candidate reviewers based on matching between the experts' supplied keywords (for the submission) and keywords characterising reviewers' expertise, as specified in reviewer profiles. Alternatives include substituting or complementing keywords with subject areas or topics defined in domain specific topic lists. The key issue with this approach is the same issue with the keyword-based searching in general, namely ambiguity and pure syntactic matching, without the ability to do matching based on semantic similarity of subject areas and/or topics. In addition, subject areas and keywords in the reviewers' profiles are typically supplied by experts when registering with the review system and are rarely updated, which often results in outdated reviewer profiles, inaccurately depicting reviewers' competences, interests, and expertise.

### SUMMARY OF VARIOUS EMBODIMENTS

In one broad aspect, at least one embodiment described herein provides a computer implemented method for performing Portfolio Expert Alignment (PEA) for generating electronic profile data for expert reviewers and/or recommending one or more expert reviewers for reviewing one or more input electronic documents, wherein the method is performed by at least one processor and the method comprises: receiving a plurality of electronic portfolio documents for each of the expert reviewers; generating electronic expert reviewer profiles for the expert reviewers where ethe electronic expert reviewer profiles are machine interpretable representations of the experts' portfolio based on the electronic portfolio documents; receiving the one or more input electronic paper documents; generating at least one electronic representation for at least one of the input electronic paper documents; searching the electronic expert reviewer profiles to determine at least one match between the at least one electronic representation of the at least one input electronic paper document and one or more of the electronic expert reviewer profiles; and generating a recommendation for one or more of the expert reviewers for reviewing the at least one input electronic paper document based on the at least one match.

In at least one embodiment, the method comprises using an Expert Profile Generator for creating the electronic expert reviewer profile from the electronic portfolio documents for the expert reviewer, where the electronic expert reviewer profile comprises a block of text that summarizes a contribution history for the expert reviewer.

In at least one embodiment, the method comprises using a Vocabulary Builder for generating an N-element floating point vector representation for every unique word vector obtained from the block of text.

In at least one embodiment, the method comprises using an Input Matricizer that processes the bock of text and the unique word vectors to construct an M×N floating-point matrix representation of the block of text.

In at least one embodiment, the method comprises using a Sequencer for creating multiple deep learning models that are used to compute subject matter similarity between two electronic paper documents, between two electronic expert reviewer profiles and/or between an electronic paper document and electronic expert reviewer profile.

In at least one embodiment, the method comprises using a Sequence Model (SM) deep learning model that generates an embedded context expert vector that embodies an expert reviewer's area of specialty, history, proficiency, and/or relevance to state-of-the-art.

In at least one embodiment, the method comprises using an Input Vectorizer to averages the output of the SM deep learning models into a single embedded context vector.

In at least one embodiment, the method comprises comparing the single embedded context vector with other embedded context vectors for determining subject matter similarity.

In at least one embodiment, the method comprises using Serendipity to cause the SM models to produce a different embedded context vector for the same input thus providing alternative recommendations for the expert reviewers.

In at least one embodiment, the method comprises using an Expert Recommender to generate an embedded context vector by using an Expert Profile Generator, an Input Matricizer, and an Input Vectorizer.

In at least one embodiment, the method comprises using the Expert Recommender to retrieve nearest top-k embedded context vectors stored in an experts database.

In at least one embodiment, the method comprises using an AI Explainer to provide insight as to why a set of expert reviewers were recommended as reviewers for a given electronic paper document.

A computer implemented method for performing Batch Alignment (BULK) in which a plurality of electronic paper documents are assigned to a plurality of expert reviewers for review, wherein the method is performed by at least one processor and the method comprises:
receiving electronic representations of the plurality of electronic paper documents;
receiving electronic representations of the plurality of expert reviewers; and
optimizing an assignment of the plurality of electronic paper documents to multiple expert reviewers based on reviewer suitability and individual paper and expert constraints.

The method of claim 13, wherein the method comprises using a Constrainer that provides limits on assigning one or more expert reviewers or one or more electronic documents based on certain criteria for how the electronic paper documents are assigned to the expert reviewers.

The method of claim 14, wherein the criteria include quorum, expert preferences, and/or conflicts of interest.

The method of any one of claims 13 to 15, wherein the method comprises using a Synchronizer to produce a cartesian product representing a suitability of a plurality of expert reviewers for reviewing a plurality of electronic paper documents.

The method of any one of claims 13 to 16, wherein the method further comprises using a Solver to construct a minimum weight spanning forest that represents one solution of the batch assignment of electronic paper documents to suitable expert reviewers.

In another broad aspect, at least one embodiment described herein provides an electronic device for generating electronic profile data for expert reviewers and/or generating recommendations for one or more expert reviewers for performing a task, wherein the device comprises: a memory unit storing program instructions for performing one or more functions related to generating the electronic profile data and/or generating the recommendations; a processor unit that is coupled to the memory unit, the processor unit having one or more processors that, when executing the program instructions, are configured to perform a method that is defined according to the teachings herein.

In another broad aspect, at least one embodiment described herein provides a computer readable medium comprising a plurality of instructions that are executable on one or more processors of a device for configuring the one or more processors to perform a method that is defined according to the teachings herein.

It will be appreciated that the foregoing summary sets out representative aspects of embodiments to assist skilled readers in understanding the following detailed description. Other features and advantages of the present application will become apparent from the following detailed description taken together with the accompanying drawings. It should be understood, however, that the detailed description and the specific examples are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 is a block diagram of an example embodiment of a system for recommending expert reviewers for performing quality assessment of an electronic work.

FIG. 2 is a block diagram showing an example embodiment of the data flow and functions for the main software components which may be used by the system of FIG. 1 including subsystems for Portfolio Expert Alignment (PEA) and Batch Assignment (BULK).

FIG. 3 is a block diagram of an example embodiment of a method that may be used to perform the functions of various software components of the PEA subsystem.

FIG. 4 shows an example of how the Input Matricizer converts natural language text to matrix.

FIG. 5 shows an example embodiment of the structure of a Sequence Model (SM) Deep Learning Model.

FIG. 6 shows an example embodiment of a flowchart for a method that may be performed by the Expert Recommender.

FIG. 7 is an illustration of an example of serendipity by random removal of neuron connections.

FIG. 8 shows an example embodiment of a pipeline that may be used by the AI Explainer.

FIG. 9 shows an example embodiment of software components that

may be used by the Batch Assignment (BULK) subsystem.

FIG. 10 shows an example embodiment of the data flow and functions that may be used by the Constrainer.

FIG. 11 shows an example embodiment of the software components and data flow that may be used by the Synchronizer.

FIG. 12 shows an example embodiment of the software components and data flow that may be used by the Solver.

Further aspects and features of the example embodiments described herein will appear from the following description taken together with the accompanying drawings.

### DETAILED DESCRIPTION OF THE EMBODIMENTS

The headings and Abstract of the Disclosure provided herein are for convenience only and do not interpret the scope or meaning of the embodiments.

Various embodiments in accordance with the teachings herein will be described below to provide examples of at least one embodiment of the claimed subject matter. No embodiment described herein limits any claimed subject matter. The claimed subject matter is not limited to devices, systems or methods having all of the features of any one of the devices, systems or methods described below or to features common to multiple or all of the devices, systems or methods described herein. It is possible that there may be a device, system or method described herein that is not an embodiment of any claimed subject matter. Any subject matter that is described herein that is not claimed in this document may be the subject matter of another protective instrument, for example, a continuing patent application, and the applicants, inventors or owners do not intend to abandon, disclaim or dedicate to the public any such subject matter by its disclosure in this document.

It will be appreciated that for simplicity and clarity of illustration, where considered appropriate, reference numerals may be repeated among the Figures to indicate corresponding or analogous elements or steps. In addition, numerous specific details are set forth in order to provide a thorough understanding of the embodiments described herein. However, it will be understood by those of ordinary skill in the art that the embodiments described herein may be practised without these specific details. In other instances, well-known methods, procedures and components have not been described in detail so as not to obscure the embodiments described herein. Also, the description is not to be considered as limiting the scope of the embodiments described herein.

It should also be noted that the terms “coupled”, or “coupling” as used

herein can have several different meanings depending in the context in which these terms are used. For example, the terms coupled, or coupling can have an electrical connotation. For example, as used herein, the terms coupled or coupling can indicate that two elements or devices can be directly connected to one another or connected to one another through one or more intermediate elements or devices via an electrical or magnetic signal, an electrical connection, or an electrical element. Furthermore, certain coupled electrical elements may send and/or receive data.

Unless the context requires otherwise, throughout the specification and claims which follow, the word “comprise” and variations thereof, such as, “comprises” and “comprising” are to be construed in an open, inclusive sense, that is, as “including, but not limited to”.

Various terms used throughout the present description may be read and understood as follows, unless the context indicates otherwise: singular articles and pronouns as used throughout include their plural forms, and vice versa; similarly, gendered pronouns include their counterpart pronouns so that pronouns should not be understood as limiting anything described herein to use, implementation, performance, etc. by a single gender. Further definitions for terms may be set out herein; these may apply to prior and subsequent instances of those terms, as will be understood from a reading of the present description.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term, such as by 1%, 2%, 5% or 10%, for example, if this deviation does not negate the meaning of the term it modifies.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, or 10%, for example.

Reference throughout this specification to “one embodiment”, “an embodiment”, “at least one embodiment” or “some embodiments” means that one or more particular features, structures, or characteristics may be combined in any suitable manner in one or more embodiments, unless otherwise specified to be not combinable or to be alternative options.

As used in this specification and the appended claims, the singular forms “a,” “an,” and “the” include plural referents unless the content clearly dictates otherwise. It should also be noted that the term “or” is generally employed in its broadest sense, that is, as meaning “and/or” unless the content clearly dictates otherwise.

Similarly, throughout this specification and the appended claims the term “communicative” as in “communicative pathway,” “communicative coupling,” and in variants such as “communicatively coupled,” is generally used to refer to any engineered arrangement for transferring and/or exchanging information. Examples of communicative pathways include, but are not limited to, electrically conductive pathways (e.g., electrically conductive wires, physiological signal conduction), electromagnetically radiative pathways (e.g., radio waves), or any combination thereof. Examples of communicative couplings include, but are not limited to, electrical couplings, magnetic couplings, radio couplings, or any combination thereof.

Throughout this specification and the appended claims, infinitive verb forms are often used. Examples include, without limitation: “to detect,” “to provide,” “to transmit,” “to communicate,” “to process,” “to route,” and the like. Unless the specific context requires otherwise, such infinitive verb forms are used in an open, inclusive sense, that is as “to, at least, detect,” to, at least, provide,” “to, at least, transmit,” and so on.

A portion of the example embodiments of the systems, devices, or methods described in accordance with the teachings herein may be implemented as a combination of hardware or software. For example, a portion of the embodiments described herein may be implemented, at least in part, by using one or more computer programs, executing on one or more programmable devices comprising at least one processing element, and at least one data storage element (including volatile and/or non-volatile memory). These devices may also have at least one input device (e.g., a keyboard, a mouse, a touchscreen, and the like) and at least one output device (e.g., a display screen, a printer, a wireless radio, and the like) depending on the nature of the device.

For example, and without limitation, the programmable devices may include servers, personal computers, laptops, tablets, personal data assistants (PDA), smart phones, and other suitable mobile devices. Program code can be applied to input data to perform the functions described herein and to generate output data. The output data can be supplied to one or more output devices for outputting to one or more users.

It should also be noted that there may be some elements that are used to implement at least part of the embodiments described herein that may be implemented via software that is written in a high-level procedural language such or object-oriented programming. The program code may be written in C, C++ or any other suitable programming language and may comprise modules or classes, as is known to those skilled in object-oriented programming.

Alternatively, or in addition thereto, some of these elements implemented via software may be written in assembly language, machine language, or firmware as needed. In either case, the language may be a compiled or an interpreted language.

At least some of the software programs used to implement at least one of the embodiments described herein may be stored on a storage media or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions, such as program code, for one or more processors. The program code may be preinstalled and embedded during manufacture and/or may be later installed as an update for an already deployed computing system. The medium may be provided in various forms, including non-transitory forms such as, but not limited to, one or more diskettes, compact disks, tapes, chips, and magnetic and electronic storage. In alternative embodiments, the medium may be transitory in nature such as, but not limited to, wire-line transmissions, satellite transmissions, internet transmissions (e.g., downloads), media, digital and analog signals, and the like. The computer useable instructions may also be in various formats, including compiled and non-compiled code.

Accordingly, any module, unit, component, server, computer, terminal or device described herein that executes software instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of the device or accessible or connectable thereto.

Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, software application or software module herein described may be implemented using computer readable/executable instructions that may be stored or otherwise held by such computer readable media and executed by the one or more processors.

The teachings herein may be used to overcome one or more of the deficiencies of existing solutions and allow for seamlessly pairing an electronic submission with one or more reviewers so that at least one of the above stated requirements, such as competence, interest, fairness, and/or expansion of the reviewer pool, are met.

For example, in a first aspect, in accordance with the teachings herein, there is provided at least one embodiment of a system and method that employ Artificial Intelligence (AI) and Natural Language Processing (NLP) methods to automatically create electronic expert reviewer profile from the professional contribution history data (e.g., any combination of at least one publication document, at least one grant application document, at least one presentation document, at least one patent document, and at least one resume document) for expert reviewers that are included in the system. These various documents are electronic documents. The generation of these novel electronic expert profiles may be done, without any human assistance, for tens, hundreds, thousands or even millions of subject matter experts where the electronic expert profile includes data that embodies the area of expertise, both past and present, for these experts.

As another example, in a second aspect, in accordance with the teachings herein, there is provided at least one embodiment of a system and method that employ Artificial Intelligence (AI) and Natural Language Processing (NLP) methods that may use the expert reviewer profile data, to recommend the most suitable experts to evaluate the quality of a particular work, in a manner that more effectively addresses the requirements for such pairings (e.g., subject matter competence, interest, fairness, and/or expansion of the experts pool). Such recommendations have a multitude of impactful applications such as, but not limited to, recommending reviewers for evaluating a research paper, recommending an experts team to collaborate on a project, and/or recommending evaluators for the assessment of grant applications, for example. In doing so, the invention contributes to both efficiency and effectiveness of any process that requires recruitment of experts, by both speeding up the process and enabling optimal expert selection.

As another example, in a third aspect, in accordance with the teachings herein, there is provided at least one embodiment of a system and method that employ Artificial Intelligence (AI) and Natural Language Processing (NLP) methods that may, without any human assistance, create an electronic representation of various aspects of an electronic submission, including but not limited to: a title, an abstract, keywords, the full text of the electronic submission or any combination thereof, that embodies the semantics of the electronic submission.

As another example, in a fourth aspect, in accordance with the teachings herein, there is provided at least one embodiment of a system and method that employ Artificial Intelligence (AI) and Natural Language Processing (NLP) methods that may use similarity metrics, to compare and rank electronic representations derived from the electronic expert profiles against the electronic representation of various aspects of an electronic submission to recommend suitable experts from the expert pool to review the electronic submission.

As another example, in a fifth aspect, in accordance with the teachings herein, there is provided at least one embodiment of a system and method that employ Artificial Intelligence (AI) and Natural Language Processing (NLP) methods that may take into account electronic representations of a number of expert profiles in combination with certain considerations such as, but not limited to, any combination of conflicts-of-interests, language skills, years of activity, contributions to specific topic areas, and number of contributions before recommending experts as reviewers for specific electronic submissions.

As another example, in a sixth aspect, in accordance with the teachings herein, there is provided at least one embodiment of a system and method that employ Artificial Intelligence (AI) and Natural Language Processing (NLP) methods that may select the distribution of available reviewers for a batch of electronic papers, such as either a single electronic paper to a single reviewer (1-to-1) or single electronic paper to many reviewers (1-to-many), while conforming to one or more reviewer preferences such as, but not limited to, any combination of topical areas, ideal number of reviews, timelines for review and one or more electronic paper constraints (e.g.: any combination of number of required reviews, conflicts of interest, diversity and/or complementarity of interests).

It should be understood that, in accordance with the teachings herein, there may be at least one embodiment of a system and a method that incorporates any combination of the first to sixth aspects previously described.

### Definitions:

The following terms are used throughout this specification and may be understood to have the following meanings:
Portfolio: A collection of electronic documents offering evidence of an individual's achievements, accomplishments, or general work engagement. The electronic documents include, but are not limited to, any combination of at least one publication, at least one grant application, at least one presentation, at least one patent, at least one resume, at least one curriculum vitae, at least one social media post, and at least one blog.
Expert Profile: An electronic data structure that is a machine interpretable representation of an individual's professional contribution history or body of work that includes their portfolio and includes data indicative of their expertise, proficiency, and/or relevancy to a field of study or specialization.
Paper: any electronic submission or electronic work (e.g.: a publication, a grant application, a manuscript, a case study, a presentation, a patent, a resume, a curriculum vitae, a social media post, and a blog) in whole or in part (e.g.: title, abstract, summary, paragraph, conclusion, and/or full text).
Expert Reviewer: any expert tasked with judging a paper based on a set of evaluation criteria such as but not limited to originality, novelty, correctness, quality, and contribution.
Selection Committee: a group of individuals tasked to judge the correctness and/or quality of the paper-to-expert reviewer assignments generated by at least one embodiment of the systems and methods described herein.
Sequence Model (SM): a deep learning Artificial intelligence (i.e., machine learning) model that utilizes a sequence or time series as input. Such models include, but are not limited to, Recurrent Neural Networks (RNN), Long Short Term Memory (LSTM), and Transformers, for example. These models learn to encode information that they receive in their input in the form of sequences or time series, which are then used to perform classification, regression, or sequence generation.

### System Architecture

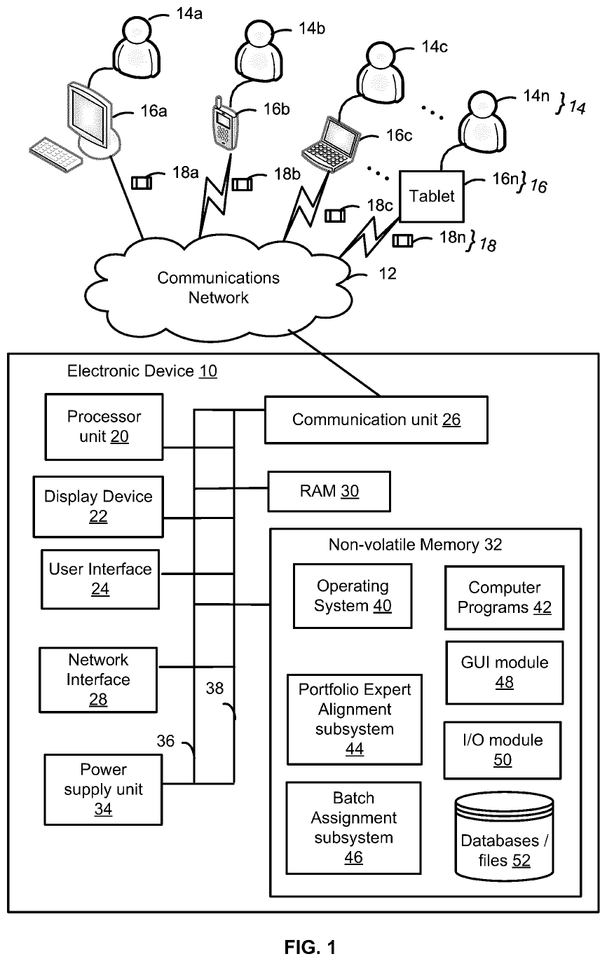

Referring now to FIG. 1, shown therein is a block diagram of an example embodiment of a system including an electronic device 10 for recommending expert reviewers for performing quality assessment of an electronic work. As shown in FIG. 1, the electronic work may be sent by one or more of a plurality of users 14 that may access the computing device 10 through a communications network 12 over certain time periods. In this example, the plurality of users 14 includes users 14a, 14b, 14c up to 14n that access the communications network 12 using a variety of electronic devices 16. The electronic devices 16 have at least one input device (e.g., a keyboard or touchscreen, etc.) and at least one output device (e.g., a display screen, etc.). The electronic devices 16 may include, but are not limited to, a desktop computer 16a, a smart phone 16b, a laptop 16c, a tablet 16n and the like to send electronic messages 18. The electronic messages 54 may comprise a variety of different types of electronic documents 18a, 18b, 18c to 18n such as one of the papers defined herein.

The communications network 12 can be any suitable network that can be accessed by the electronic device 10 and the various user devices 16. For example, the communications network 12 may be an internal institutional network, such as a corporate network or an educational institution network, which may be implemented using a Local Area Network (LAN) or intranet. In other cases, the communications network 12 can be an external network such as the Internet or another external data communications network, which is accessible by using a web browser on one of the electronic devices 16 to browse one or more web pages presented over the Internet.

In some cases, some the electronic devices 16 may be wirelessly connected to an access point (e.g., a wireless router, a cellular communications tower, etc.) for the communications network 12. In other cases, some of the electronic devices 16 may be coupled via a wired connection to the communications network 12. These wired or wireless connections depend in part on the implementation of the communications network 12.

The electronic device 10 is generally a computing device with communication capabilities such as a server. The electronic device 10 generally includes a number of functional hardware and software components for facilitating the recommendation of expert reviewers for performing quality assessment of an electronic work. Accordingly, the computing device 10 comprises a processor unit 20, a display device 22, a user interface 24, a communication unit 26, a network interface 28, a memory unit including volatile memory 30 (such as Random Access Memory (RAM)) and non-volatile memory 32, a power supply unit 34, as well as a communication bus 36 and voltage rails (e.g., power bus) 38. The communication bus 36 enables the processor unit 20 to communicate with the other components of the electronic device 10. The various elements of the electronic device 10 can receive power from voltage rails 38 that are provided by the power supply unit 34. The volatile memory 30 may be used by the processor unit 20 to execute various programs including software instructions that may be stored in the non-volatile memory 32 such as an operating system 40, computer programs 42, a Portfolio Expert Alignment (PEA) subsystem 44, a Batch Assignment (BULK) subsystem as well as various databases and a data files 52.

The electronic device 10 may be implemented in a variety of ways such as via a desktop computer, a laptop, a mobile device or cloud components. The electronic device 10 is provided as an example and there can be other embodiments of the electronic device 10 with different components or a different configuration of the components as long as the functionality described herein is provided. For instance, in alternative embodiments, the functions of the electronic device 10 can be run on two or more computing devices with the functions being distributed among these computing devices that may be locally or remotely distributed, such as cloud-computing resources for example. In another example embodiment, there may also be multiple backup network servers (not shown) that may duplicate some or all of the functionality provided by the electronic device 10 and the data stored on the various memory components of the memory unit. The backup servers may also be used to prevent undesired data loss and for data recovery in the event of a disaster such as, but not limited to, an electrical outage, a fire, a flood or theft, for example.

The processor unit 20 is used to execute the program instructions for the operating system 40, the various computer programs 42 and other software programs, as described below in greater detail. In embodiments where there are two or more processors, these processors may function in parallel and perform certain functions. The processor unit 20 controls the operation of the electronic device 10 and may communicate with at least one element of the electronic device 10, such as the communication unit 26 and the user interface 24, in order to receive or send information or control signals, as well as the memory elements 30 and 32 for executing various software instructions to perform certain functions described herein as well as to retrieve and/or store data. The processor unit 20 may be implemented using one or more suitable processors, controllers, digital signal processors and/or other logic circuity including Application Specific Integrated Circuits (ASIC), for example, that can provide sufficient processing power depending on the configuration and operational requirements of the electronic device 10. For example, the processor unit 20 may include a high-performance processor.

The display device 22 can be any suitable display that provides visual information depending on the configuration of the electronic device 10. For instance, the display device 22 can be a flat screen monitor and the like if the electronic device 10 is a desktop computer. In other cases, the display device 22 can be a display suitable for a laptop, tablet or handheld device such as an LCD-based display and the like. The display device 22 can provide notifications to the user, such as an administrator, of the electronic device 10. In some cases, the display device 22 may be used to provide one or more GUIs through an Application Programming Interface. A user may then interact with the one or more GUIs for configuring the electronic device 10 to operate in a certain fashion. In at least one embodiment, the display device 22 may be optional.

The user interface 24 enables an administrator or user to provide input to the electronic device 10 via an input device, which may be, for example, any combination of a mouse, a keyboard, a trackpad, a thumbwheel, a trackball, voice recognition, a touchscreen and the like depending on the particular implementation of the electronic device 10. The user interface 24 also outputs information to output devices, which may be, for example, any combination of the display device 22, a printer or a speaker.

The communication unit 26 can be a radio that communicates utilizing CDMA, GSM, GPRS or Bluetooth protocol according to standards such as IEEE 802.11a, 802.11b, 802.11g, or 802.11n. Accordingly, the communication unit 26 can provide the processor unit 20 with a way of communicating wirelessly, over the communications network 12, with certain components of the system or with other devices or computers that are remote from the electronic device 10.

The network interface 28 permits communication with a network, or other electronic devices and/or servers, which may be remotely located from the electronic device 10 but accessible by some network. The network interface 28 may also include other interfaces that allows the electronic device 10 to communicate with other devices or computers. For example, the network interface 28 may include any combination of an Internet, Local Area Network (LAN), Ethernet, Firewire, modem or digital subscriber line connection, as well as a serial port, a parallel port or a USB port that provides USB connectivity.

The RAM 30 and the non-volatile storage 32 may be provided in a memory unit or a data store that is accessible by the processor unit 20. The RAM 30 provides relatively responsive volatile storage to the processor unit 20. The non-volatile storage 32 may be provided using ROM, one or more hard drives, one or more flash drives or some other suitable data storage elements. The non-volatile storage 32 stores program instructions, including computer-executable instructions, for implementing the operating system 40, various computer programs 41, the PEA subsystem 44, the BULK subsystem 46 and other software modules, as well as storing any data used by these software modules. The operating system 40 provides various basic operational processes for the electronic device 10. The computer programs 42 may be other programs that are typically used run on a computing device such as, but not limited to, an email program, a word processing program and a spreadsheet program. The data may be stored in one or more databases and/or data files 52, such as for electronic data relating to expert reviewer profiles and/or electronic data related to electronic documents that have been submitted for review by one or more experts. The data files 52 can also be used to store various parameter values that are used by the software programs of PEA subsystem 44 and the BULK subsystem 46 including any machine learning models and related training data. The database/data files 52 can also store other data required for the operation of the PEA subsystem 44 and/or BULK subsystem 46 or the operating system such as dynamically linked libraries and the like. The databases 52 can be accessed by applications that are executing on the electronic device 10. The databases 52 may be implemented as a relational database such as an SQL database or a non-relational noSQL database. Additionally, or alternatively, a separate computing device may store at least some portions of the databases and/or data files 52.

The power supply unit 34 can be any suitable power source or power conversion hardware that provides power to the various components of the electronic device 10. The power supply unit 34 may be a power adaptor or a rechargeable battery pack depending on the implementation of the electronic device 10 as is known by those skilled in the art. In some cases, the power supply unit 34 may include a surge protector that is connected to a mains power line and a power converter that is connected to the surge protector (both not shown). The surge protector protects the power supply unit 34 from any voltage or current spikes in the main power line and the power converter converts the power to a lower level that is suitable for use by the various elements of the electronic device 10. In other embodiments, the power supply unit 34 may include other components for providing power or backup power as is known by those skilled in the art.

In at least one embodiment, the electronic device 10 further includes a number of software modules/programs with software instructions that are to be executed on the processor unit 20 for generating electronic profile data for expert reviewers and/or recommending expert reviewers for reviewing one or more electronic documents. The software programs that may be executed by the processor unit 20 include, but are not limited to, the PEA subsystem 44, the BULK subsystem 46, the GUI module 48, and the input/output (I/O) module 50. It should be noted that in alternative embodiments, the software instructions may be organized in a different manner, i.e., by a different number of software modules, as long as the functionality described herein is provided.

The PEA subsystem 44 includes program instructions that when executed by the processor unit 20 configures at least one processor and/or logic circuitry to implement one or more methods for generating a database of expert candidate reviewers. In at least one embodiment, this may be done through the use of deep learning artificial intelligence. The PEA subsystem 44 includes software instructions which allow the PEA subsystem 44 to learn experts' specialty areas from their electronic portfolios, which may then be used to recommend one or more top subject matter experts as reviewers for an electronic paper.

For example, the PEA subsystem 44 may instruct the processor unit 20 to execute the software instructions of the GUI module 48 to provide a user interface to allow a user to provide electronic documents for review and/or electronic documents for generating an electronic expert reviewer profile. The PEA subsystem 44 may then generate the electronic expert reviewer profile data and/or an electronic representation of the electronic documents needing review. The PEA subsystem 44 may provide such functionality by instructing the processor unit 20 to execute the software instructions for the I/O module 50 and other programs whose functionality is described in further detail below.

The Batch Assignment (BULK) subsystem 46 includes program instructions that when executed by the processor unit 20 configures at least one processor and/or logic circuitry to implement one or more methods for receiving a batch of electronic papers as input, and works with the PEA subsystem 44, to assign individual electronic papers to one or more reviewers in a way that best utilizes subject matter experts while adhering to constraints such as, but not limited to, any combination of expert availability, expert subject matter preferences, expert workload, paper quorum, and conflicts of interest avoidance.

When executing the PEA subsystem 44 or the BULK subsystem 46, the processor unit 20 may store various operational parameters, and user data. In at least one embodiment, the processor unit 20 may be configured to store such data on a remote data store, such as in the cloud for example. In at least one embodiment, alternatively or in addition, the processor unit 20 may be configured to communicate with other devices to send any portion of the aforementioned data to one or more of these devices. This communication may also include email communication or other forms of electronic messaging.

The GUI module 48 includes program instructions that, when executed by the processor unit 20, configure at least one processor and/or other logic circuitry to generate various GUIs that may be displayed on the display device 22 or accessible by the electronic devices 16 used by the user 14 for display on the electronic devices 16 to allow the user to perform various functions such as sending their electronic documents to create an electronic expert reviewer profile and/or to submit electronic documents for review. The GUI module 48 may also include software instructions for displaying various results during the operation of the PEA subsystem 44 and/or the BULK subsystem 46.

The I/O module 128 includes software instructions that, when executed by the processor unit 20, configures at least one processor and/or logic circuitry, to store data in the databases/files 52 or retrieve data from the databases/files 52. For example, any input data from the user can be stored. In addition, any generated data from the PEA subsystem 44 and/or the BULK subsystem 46 may be provided to the input/output module 50 and the GUI module 48 for display on the display device 22 or one of th user devices 16. Alternatively, or in addition thereto, such data may be provided by the input/output module 50 to the communication unit 26 or the network interface 28 for transmission to another electronic device and/or remote storage device.

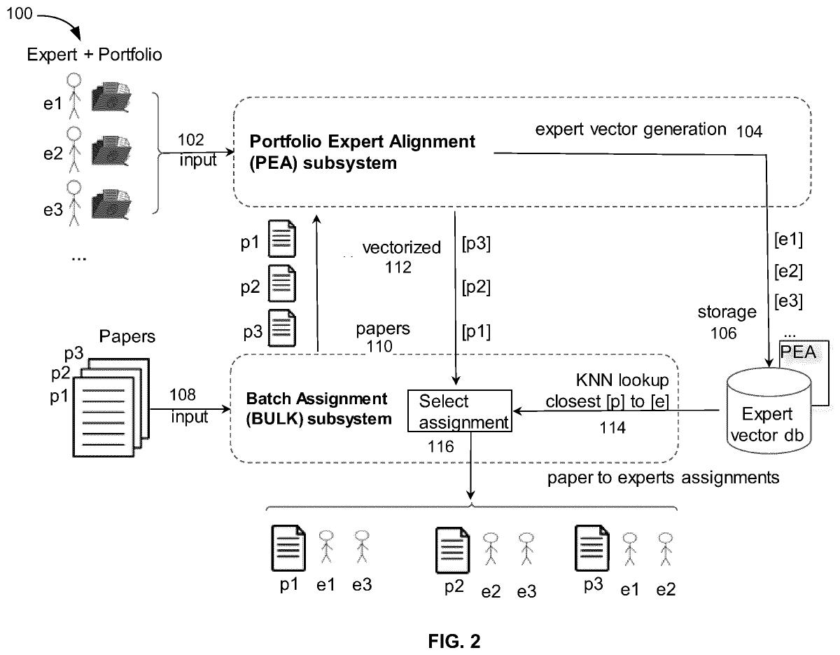

Referring now to FIG. 2, shown therein is a diagram of an example embodiment of a method 100 used by the main software components of the electronic device 10 of FIG. 1 including the Portfolio Expert Alignment (PEA) subsystem 44 and the Batch Assignment (BULK) subsystem 46.

At step 102, the users 14 include one or more experts e1, e2, e2 who submit, via the electronic devices 16 and electronic messages 18, electronic documents that are indicative of their portfolios. These electronic documents may be referred to as electronic portfolio documents. The electronic portfolio documents are submitted as input to the PEA subsystem 44. The usage of the term electronic messages 18 throughout the specification should be understood to be electronic messages such as e-mail messages that include electronic paper documents and/or electronic portfolio documents that are transmitted over a communications network such as communications network 12 or the electronic messages 18 may be electronic paper documents and/or electronic portfolio documents that are uploaded by a user at a portal or website via a GUI that may be provided by the GUI module 48.

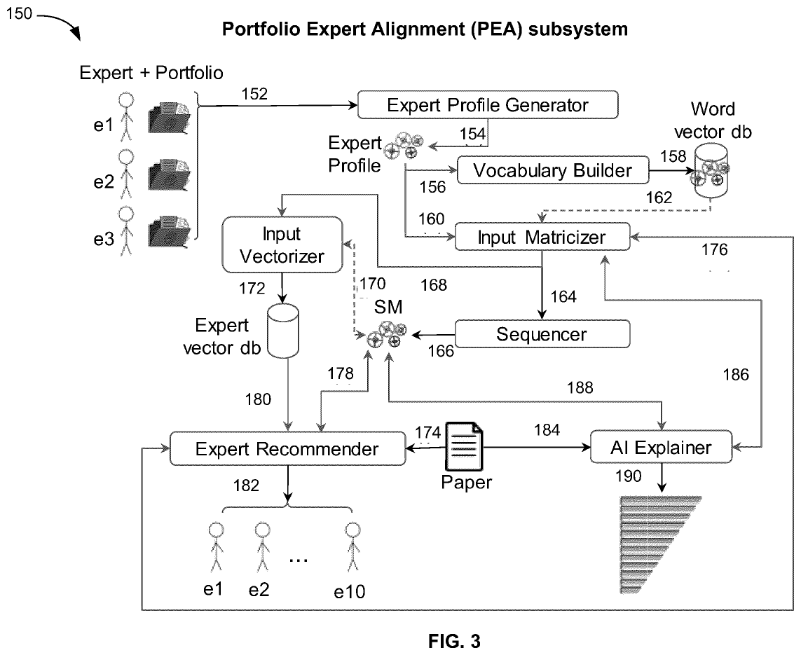

At step 104, the PEA subsystem 44 generates, for each expert, an electronic expert reviewer profile as a machine interpretable representation of each expert's portfolio based on the electronic documents that they submitted at step 102. For example, the machine interpretable representation may be one or more vectors that are generated for each expert reviewer. The PEA subsystem 44 may perform this function according to various techniques, an example of which is provided as method 150 in FIG. 3.

At step 106, the machine interpretable representation of the generated electronic expert reviewer profiles are stored in a database, such as an expert vector database which may be one of the databases 52, for future use (e.g., in performing certain comparisons).

At step 108, a set of papers (i.e., electronic paper documents) is supplied to the BULK subsystem 46. There may be any number of these electronic paper documents but in the examples shown herein it is assumed that there are three electronic paper documents (e.g., p1, p2, p3) for simplicity of illustration. The electronic paper documents may be submitted by other users 14, via their devices 16 and electronic message 18, such as people from academic institutions or academic journals who need an expert review of an electronic paper document.

At step 110. the electronic paper documents are individually submitted to the PEA subsystem 44 which returns an electronic representation for each paper at step 112. For example, the representation for each paper p1, p2 and p3 may be paper electronic representations such as vectors [p1], [p2] and [p3], respectively.

At step 114, for each electronic paper document that was submitted from the set p1, p2 and p3 and which have electronic paper representations [p1], [p2], [p3], the expert vector database (which may also be referred to as the expert profiles database) is searched to determine the expert reviewer(s) who are the highest matches , e.g., the closest match, or near the highest matches to the electronic paper representation created in step 112. The closest match may be determined using a variety of techniques such as, but not limited to, the nearest neighbor technique.

At step 116, the individual electronic papers p1, p2 p3 are assigned to the top-k experts identified by the system as best suited to perform the review where k is an integer and is not necessarily equal to the number of electronic paper documents. For instance, in the example of FIG. 2 there are two experts e1 and e2 that are both assigned each of the electronic paper documents. Accordingly, this assignment is not limited to a one-to-one pairing (e.g., one electronic paper document to one expert), but since a single electronic paper document can be assigned to many expert reviewers and an individual expert reviewer may have many electronic paper documents assigned to them. In at least one embodiment, a minimum and a maximum number of electronic documents that are assigned to a single reviewer may be a predefined and adjustable option that may be set such as by using the Constrainer component, for example).

### Subsystem Components

The PEA and BULK subsystems 44 and 46 may be implemented using a set of components in order to perform their various tasks. Examples of such components that may be used in at least one example embodiment are listed in Table 1 and the functionality of these components, and methods which may be used to implement these components are discussed herein.

TABLE 1
The Subsystems and their Components

| Subsystem | Components |
|---|---|
| Portfolio Expert | Expert Profile Generator |
| Alignment (PEA) | Vocabulary Builder |
| | Input Matricizer |
| | Sequencer |
| | Input Vectorizer |
| | Expert Recommender |
| | AI Explainer |
| Batch | Constrainer |
| Assignment | Synchronizer |
| (BULK) | Solver |

Components of the PEA subsystem.

Referring now to FIG. 3, shown therein is a block diagram of an example embodiment of a method 150 that may be used by the PEA subsystem 44 and associated data flow. The PEA subsystem 44 generally functions to build electronic expert review profiles from expert portfolio documents and leverage the electronic expert review profiles to recommend the best reviewers for any given electronic paper document that needs review and is provided as input.

At step 152, an expert's portfolio of electronic portfolio documents is provided as input to an Expert Profile Generator which is a program that is used to process these electronic documents to produce an expert profile text paragraph at step 154. The expert profile text paragraph is an electronic textual representation of an expert's subject matter competence. An example embodiment for the Expert Profile Generator is described later in this specification.

At step 156, all expert profile text paragraphs are collected and submitted to a Vocabulary Builder. At step 158, the Vocabulary Builder, which is a software program, is used to learn a floating-point n-element vector representation of each unique word in the expert profile text paragraph and saves this n-element vector representation in a word vector database (which is one the databases 52). An example embodiment for the Vocabulary Builder is described later in this specification.

At step 160, the expert profile text paragraph is also submitted to an Input Matricizer which is a software program that is used to construct a matrix representation, at step 162, of the expert profile text paragraph using the n-element word vectors created at step 158. An example embodiment for the Input Matricizer is described later in this specification.

At step 164, the matrices generated by the Input Matricizer are sent to a Sequencerwhich is a program that is used to train multiple sequence-to-sequence neural network models at step 166. An example embodiment for the Sequencer is described later in this specification. The neural network models may be Recurrent Neural Networks (RNN) which employs time series and is multi-layered. The RNNs may be trained using backpropagation. Data for training is the Expert and Portfolio data that is received from the expert portfolio electronic documents. An example of the training that might be performed is shown in steps 150-172 in FIG. 3.

At step 168, the matrices that were generated by the Input Matricizer are then provided to the Input Vectorizerwhich is a software program that is used to individually process the matrices to create an n-element embedded context vector representation for each matrix at step 170 using the sequence models trained at step 166. These vectors are stored in the expert vector database at step 172. An example embodiment for the Input Vectorizer is described later in this specification.

At step 174, the electronic paper document requiring reviewers is submitted to the Expert Recommender. At step 176, an Expert Recommender, which is a software program, is used to convert the electronic paper document into an n-element vector by submitting it to the Input Matricizer. The Expert Recommender then passes the output matrix into the sequence-to-sequence model to produce the n-element embedded context vector at step 178. An example embodiment for the Expert Recommender is described later in this specification.

At step 180, the top-k vectors, from the export vector database, closest to the n-element vector generated at step 178 are found. The experts represented with these top-k vectors are the most suitable as reviewers for the electronic paper document of step 174. The reviewer list, ranked by suitability, may be returned at step 182.

At step 184, the electronic paper document is (optionally) submitted to the AI Explainer, which is a software program that is used to provide an explanation of which parts of the electronic paper document are most important in determining suitable reviewers. An example embodiment for the AI Explainer is described later in this specification.

At step 186, the AI Explainer breaks the electronic paper document into “chunks” (e.g., pieces). For each chunk: the electronic document is submitted to the Input Matricizer minus the chunk. Standard off-the shelf chunker algorithms may be used to implement this aspect of the AI Explainer.

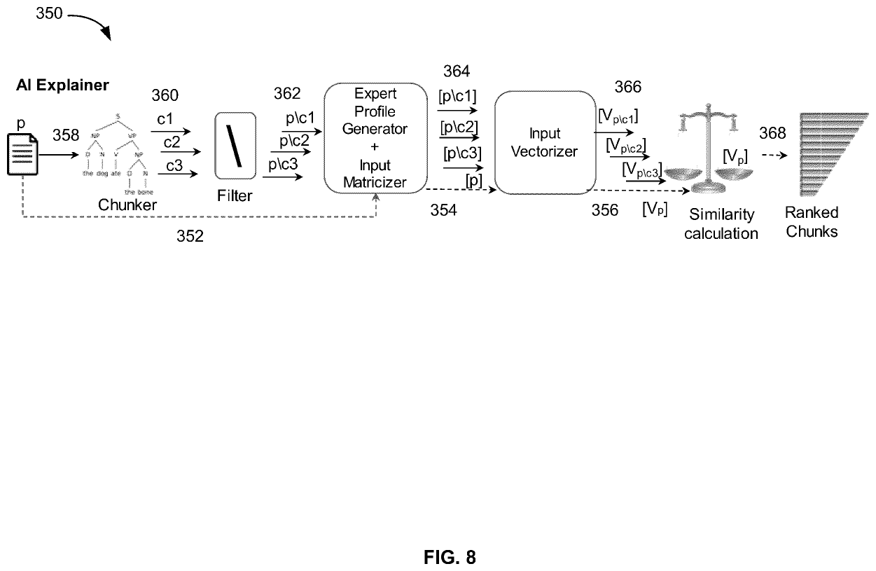

At step 188, the sequence-to-sequence model produces an n-element vector specific to the paper with the missing chunk. An example of hos this may be implemented is discussed with respect to steps 350-356 in FIG. 8.

At step 190, the paper vector with the missing chunk is compared to the n-element vector of the full electronic paper document to determine the importance of the chunk relative to the entire electronic paper document. The chunks may then be sorted by their vectors which creates a ranking starting with the most important chunk and ending with the least important chunk.

Example implementations of each of the aforementioned components of the PEA subsystem 44 now follows.

### Expert Profile Generator

An external data source, which may be one of the users 14 or may be a data store, provides as input electronic portfolio documents (representing an expert's achievements or contributions) which are received by the Expert Profile Generator. The Expert Profile Generator includes software instructions for creating a subject matter electronic expert reviewer profile that may encapsulate any combination of the expert's contribution history, expertise, proficiency, and relevancy to the current state-of-the-art in a block text (i.e., paragraph) format. The operation of the Expert Profile Generator is described below with reference to an example embodiment of a method and illustrated in Table 2 by example.

At a first step (1.1), the Expert Profile Generator retrieves the electronic profile documents for various experts, and then extracts data from the electronic portfolio documents where the extracted data includes, but is not limited to, the experts' names, collaborators they worked with, venues their work appeared in, and the paper titles and abstracts of their past work.

At a second step (1.2), the Expert Profile Generator, for each expert from step 1.1, analyzes the electronic paper documents and removes stopwords to generate processed electronic paper documents. Stopwords are commonly used words that do not offer much meaning such as (‘of’, ‘for’, ‘with’, etc.).

At a third step (1.3), for all of the processed electronic paper documents without stopwords from step 1.2, the Expert Profile Generator sorts the processed electronic paper documents by year in order from the oldest to the newest.

At a fourth step (1.4), the Expert Profile Generator concatenates the sorted electronic paper documents from step 1.3 to create a raw text expert profile paragraph that may be stored as a file.

Table 2 provides an example of expert profile generation. In this example, the expert ‘John Cuzzola’ has four contributions contained within his electronic portfolio. (1) First the electronic papers of the expert may be extracted. (2) Secondly the extracted electronic papers may be sorted them from the oldest to most recent and the stopwords removed. (3) Thirdly, the sorted list is concatenated to create the expert profile paragraph for expert ‘John Cuzzola’. This electronic profile may then be stored in a database along with, but not limited to, one or more of the expert's name, the co-authors' names, venues, affiliations, demographic information from the portfolio.

TABLE 2
An example of expert profile generation.

| (1) Publications | (2) Sorted with no | (3) Profile |
|---|---|---|
| (Title and Year) | stopwords | paragraph |
| Automated semantic | Instructor-aided | instructor-aided |
| tagging of textual | asynchronous question | asynchronous |
| content (2014) | answering system online | question answering |
| Instructor-aided | education distance | system online |
| asynchronous question | learning (2012) | education distance |
| answering system for | Semantic Tagging | learning semantic |
| online education and | Linked Open Data. | tagging linked open |
| distance learning (2012) | (2013) | data automated |
| Evolutionary fine- | Automated semantic | semantic tagging |
| tuning of automated | tagging textual content | textual content |
| semantic annotation | (2014) | evolutionary fine- |
| systems (2015) | Evolutionary fine-tuning | tuning automated |
| Semantic Tagging with | automated semantic | semantic annotation |
| Linked Open Data. | annotation systems | systems |
| (2013) | (2015) | |

### Vocabulary Builder

The raw text expert profile paragraph files produced by the Expert Profile Generator may be collated and passed to a word-to-vector vectorizer which calculates an N-element floating point vector representation for each unique word in the raw text expert profile paragraph. This vectorized word list becomes the model's vocabulary and is stored in a word vector database (see e.g., FIG. 3: steps 154-158). The operation of the Vocabulary Builder is described below with reference to an example embodiment of a method.

At a first step (2.1), the Vocabulary Builder collects (concatenate) all expert profile paragraphs together.

At a second step (2.2), the Vocabulary Builder train a word2vec model to construct an N-element vector for each word in the concatenated all expert profile paragraphs. A Word-to-Vector model (w2k) may be trained using the skip-gram or CBOW method, for example, as is known by those skilled in the field and described in further detail at: https://towardsdatascience.com/nlp-101-word2vec-skip-gram-and-cbow-93512ee24314.

At a third step (2.3), the Vocabulary Builder, for each trained N-element word vector from step 2.2, saves the word vector to the word vector database (which may be one of the databases 52).

### Input Matricizer

The electronic expert reviewer profile that is generated by the Expert Profile Generator may be transposed into an input matrix by the Input Matricizer. This is done to transform the raw text expert profile paragraphs into a matrix of floating-point numerical values that are suitable for further processing by the machine (e.g., see FIG. 3 steps 260 and 262). The operation of the Input Matricizer is described below with reference to an example embodiment of a method.

At a first step (3.1), an expert profile paragraph of word length M is supplied as input. The parameter M may be an arbitrary length and represents the current input size of an expert profile. For example, a first expert with many publications will have a large value for M while a second expert with a smaller number of publications (research papers, etc.) will have a smaller value for M compared to the first expert. In any event, M is not fixed, as it varies depending on the size of an expert's profile. Recurrent Neural Networks can handle this varying length.

At a second step (3.2), space for a matrix of size N rows by M columns is allocated where N is the size of an N-element word vector created by the Vocabulary Builder.

At a third step (3.3), for each word of the expert profile paragraph from step 3.1, reading from left-to-right of the expert profile paragraph:
at a third substep (3.3.1), the N-element word vector representation is looked up from the word vector database; and
at another third substep (3.3.2), the N-element word vector is placed to the leftmost position of the matrix of step (3.2).

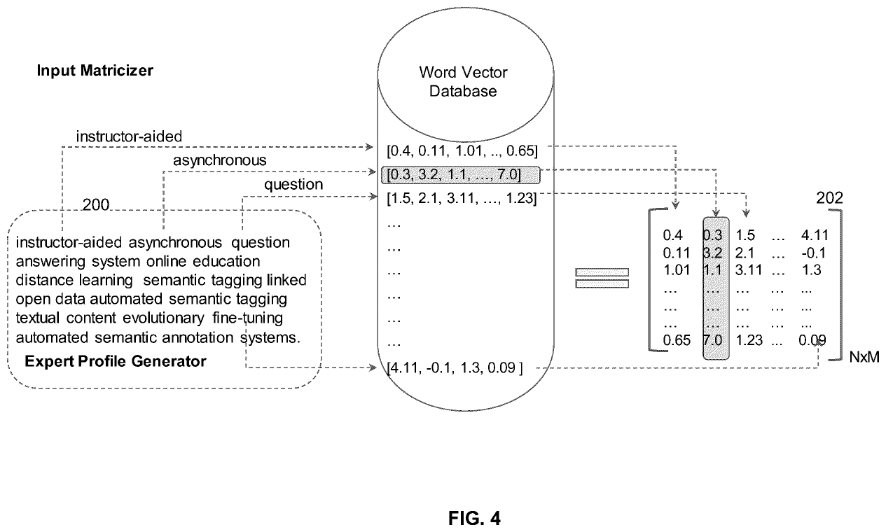

FIG. 4 illustrates this method that may be employed by the Input Matricizer. Note that the profile words 200 are inserted into this matrix 202 from left-to-right, so that the older electronic documents of an expert's portfolio are placed to the leftmost columns of the matrix 202 while the most recent are placed further to the right. This arrangement allows for the model to differentiate between an expert's past and that of their current field of focus.

### Sequencer

The Sequencer is a software program that is used to learn multiple deep learning neural network models that can generate a context vector representation of some arbitrary size k from an input matrix created by the Input Matricizer (e.g., see FIG. 3, steps 160, 164 and 166). This k-element vector is an electronic representation that encompasses at least one combination of an expert's area of specialty, history, proficiency, and relevance to today's state-of-the-art. This expert vector can then be compared to other expert or paper vectors for similarity, including similarity between authors-to-authors, similarity between papers-to-papers, or similarity between authors-to-papers comparisons.

At a first step (4.1), for every expert profile generated by the Expert Profile Generator
at a first substep (4.1.1) the expert profile is converted to a matrix form using the Input Matricizer. (e.g., see FIG. 3, steps 152, 154 and 160);
at a second substep (4.1.2) the matrix from substep (4.1.1) is inputted into a neural network for training (e.g., see FIG. 3, step 164). An example embodiment for the neural network is further discussed below.

At a second step (4.2), the neural network is saved (e.g., see FIG. 3, step 166).

At a third step (4.3), the process is repeated as the Sequencer returns to step 4.1 and repeated until network training converges.

### Sequence Model (SM).

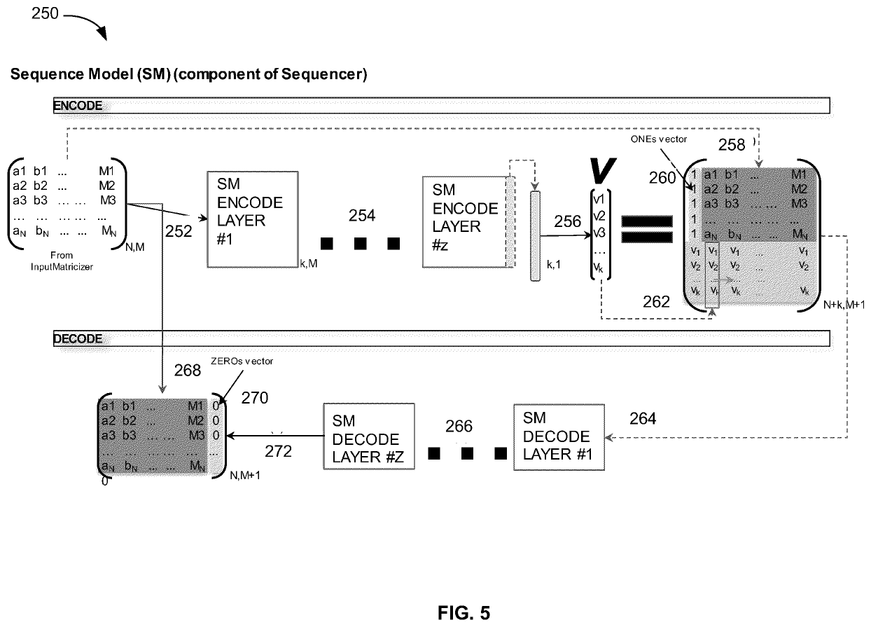

The Sequence Models are deep learning neural network models which are produced by the Sequencer. For example, during training of a neural network model, the outcome of such training is the trained neural network model. An example of this is shown in steps 252-272 in FIG. 5. The longer the neural network model is trained, the more expert profile data that will be processed which will result in a more accurate neural network model. Their purpose is to learn-by-example, by looking at many expert portfolio documents and determining similarities amongst them. Once a neural network model is produced (e.g., during the training phase), the neural network model can receive any expert portfolio document or electronic paper document and produce the context vector necessary for comparison. A method 250 that may be used for context vector creation is illustrated in the SM Architecture shown in FIG. 5. The method 250 generally comprises two parts, encode steps (including steps 252 to 262) and decode steps (including steps 264 to 272), and is explained as now follows.

At step 252, a matrix of size N×M that is generated from the Input Matricizer is received at a first Sequence Model (SM) layer, which may be implemented using a RNN.

At step 254, the output of the SM encode layer is a matrix of size k×M which is passed to multiple secondary layers (e.g., layers 2 to z) of the SM deep neural network model.

At step 256, the M^{th} column is extracted from the last layer of the SM deep neural network model to create an embedded context vector v of size k×1. This vector v encapsulates a condensed representation of the expert's body-of-work. These vectors may be stored in the expert vector database.

Referring now to FIG. 5, shown therein is FIG. 5 shows an example embodiment of the structure of a Sequence Model (SM) Deep Learning Model. An encode matrix of size N+k, M+1 may be constructed as illustrated in FIG. 5. At step 258 this matrix is first constructed by first taking the original input from step 252 (e.g., the matrix of size N×M that is generated from the Input Matricizer) and then a vector of ones is prepended as the first column of the matrix at step 260. The embedded context vector v of step 256 is appended to each column at step 262 thereby producing the N+K, M+1 matrix.

At step 264, the matrix created at step 258 is passed to an SM Decode layer, such as SM Decode layer #1.

At step 266, the output of the first SM Decode layer is sent to an arbitrary number of secondary SM layers.

At steps 268, 270 and 272, a decode matrix of size N, M+1 is constructed by taking the original matrix from the Input Matricizer of step 252 and appending a column vector of zeros.

The decode matrix may then be compared with the encode matrix produced using the last SM encode layer. The layer weights may then be adjusted so that the decode matrix is “closer” to the encode matrix. The weights may be adjusted through backpropagation. For example, the input matrix is constructed from an expert's portfolio of electronic documents and encoded as shown in steps 250-256 of FIG. 5. This encoding is a “condensed” squeezed representation of the expert's portfolio. Because it is “condensed” or tightly squeezed into basically a summary form, the neural network learns a “lean” or “summary-like” representation of the expert portfolio so it can “squeeze” all that information into a tight place (i.e.: the condensed embedding vector). The decoding step then attempts to reverse what the encoding steps did. The smaller the difference between the original input which was encoded and the decoded version created during the decoding steps (264-272) means that the decode matrix is closer to the encode matrix.

The goal for the Sequence Model is to find an embedded context vector (v of step 256) that can produce the decode matrix outputted at step 272 as closely as possible to the encode matrix of step 268 (itself) through the process of autoencoding.

### Input Vectorizer

The Sequencer is used to train Sequence Models to create an n-element vector representation from a matrix provided by the Input Matricizer (e.g., during the training phase). The Input Vectorizer uses the trained Sequence Models to produce the actual k-element vectors needed for comparison. The functionality of the Input Vectorizer is now described.

At a first step (5.1), for every electronic expert reviewer profile, an N×M matrix is created via the Input Matricizer as previously.

At a second step (5.2), the created N×M matrix is sent to all SM models produced by the Sequencerto obtain an expert vector from each model. All of these expert vectors may be combined, such as through averaging for example, to obtain one expert vector for the N×M matrix (e.g., see FIG. 3, steps 164-170).

At a third step (5.3), these expert vectors may be stored in a database for later comparison to other expert vectors (e.g., see FIG. 3, step FIG. 172). This may be done to find peers of subject matter experts with equivalent or considerably more experience in a research domain.

### Expert Recommender

The purpose of the Expert Recommender is to take an electronic paper document as an input and produce a recommendation for a set of the top-k expert reviewers for reviewing the electronic paper document as output.

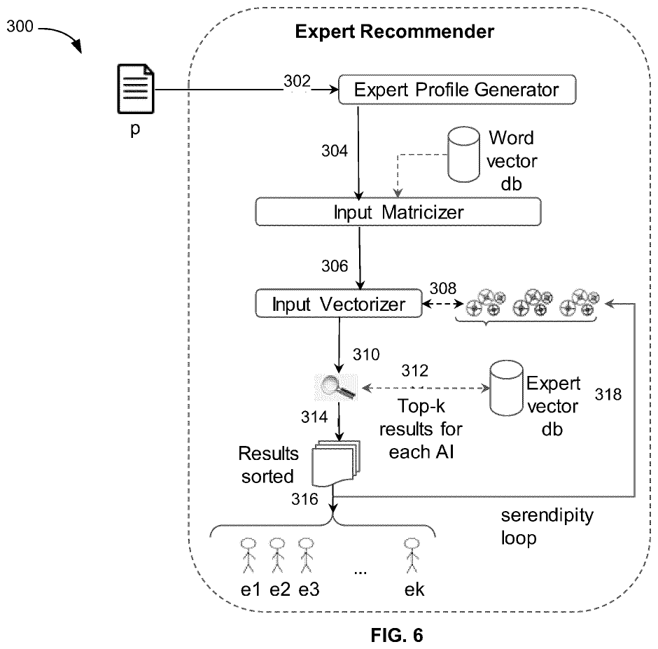

Referring now to FIG. 6, shown therein is an example embodiment of a flowchart for a method 300 that may be performed by the Expert Recommender

At step 302 an electronic paper document, which is an electronic portfolio document, is submitted to the Expert Recommender which sends it to the Expert Profile Generator which in turn creates an electronic expert review profile at step 304.

At step 306, the Input Matricizer converts the electronic expert review profile from the input electronic paper document into a matrix form .

The Input Vectorizer receives the matrix produced by the Input Matricizer at step 306 and for each of the SM models:
produces an embedded context vector at step 308 and
searches the expert vector database at step 310 for the top-k experts closest via a nearest neighbor technique to the recently produced embedded context vector of step 308 using the expert vector database at step 312.

At step 314, all of the expert vectors determined at step 310 are ranked from best to worst using some similarity measure such as, but not limited to, Euclidean distance, or cosine similarity.

At step 316, the top-k ranked experts from step 314 are determined.

At step 318, which is optional, serendipity may be performed thereby allowing the selection committee overseeing the assignments to ask for another (different) set of top-k reviewers. The neural pathways of the SM models are then modified (as will now be described) and the process repeats itself as shown in FIG. 6.

### Serendipity

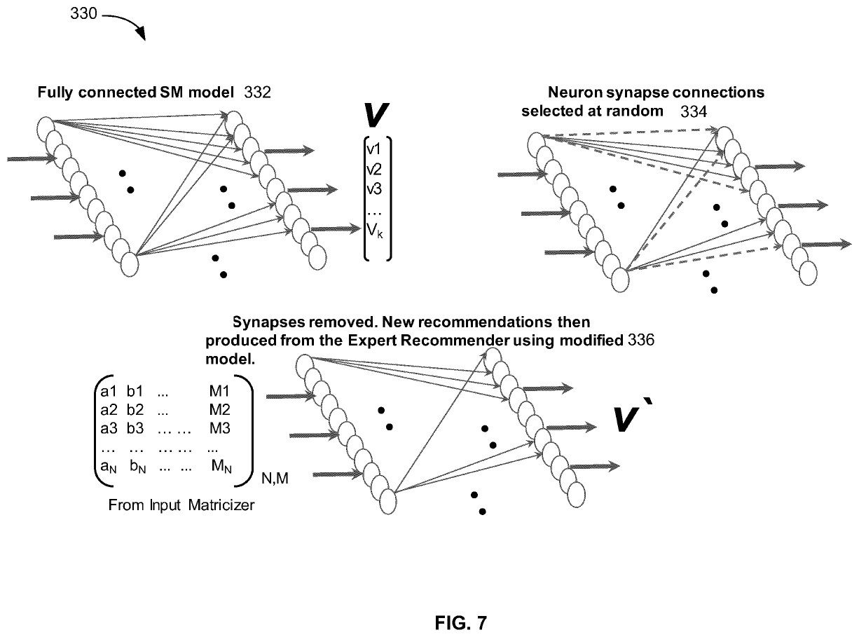

There may be times when the recommendations that are proposed may not satisfy a selection committee or perhaps the selection committee wants alternative suggestions that still meet the criteria of subject-matter expertise and level-of-proficiency for comparison. This may be done through a serendipity loop algorithm which uses synaptic weight pruning. The algorithm is described as follows and is illustrated in FIG. 7 which shows an example of a serendipity process 330 which involves the random removal of neuron connections.

At 332, for each SM model, a random percentage of neuron connections (between 1% and 5%) are selected as shown at 334 and the selected connections are then removed at 336. At this point, a previous method can continue such as the Expert Recommender.

### AI Explainer

Often it is desirable to be able to try to understand why a particular set of experts are recommended. The AI Explainer is a software program that may be able to provide this insight. The AI Explainer takes an electronic paper document as input and breaks it into multiple n-grams or “chunks”. The importance of each chunk is then ranked from high/important (i.e.: this n-gram is important to the understanding of the paper) to low/insignificant (i.e.: this n-gram does not contribute much to the context of the paper). An example of a method 350 that may be used to implement the AI explainer is provided in FIG. 8 along with an example is now provided.

At step 352, the electronic paper document p is given to the AI Explainer which utilizes the Expert Profile Generator and the Input Matricizer to produce a matrix representation [p] of the electronic paper document p at step 354.

At step 356, the matrix representation [p] is sent to the Input Vectorizer to create the embedded context vector representation [Vp] the input electronic paper document p.

At step 358, the input electronic paper document p is submitted to a lexical chunker such as, but not limited to, OpenNLP, NLTK, Stanford Parser or a similar algorithm. The chunker splits the input electronic paper document into “chunks” along noun or verb phrases at step 360. An example of this is given in Table 3 where (a) shows examples of unranked chunks.

For each chunk c1, c2, c3 (only three are shown for simplicity:
remove the chunk from the original input electronic paper document p at step 362 denoted generally as p\c (see Table 3 (b));
convert the p\c of step 362 into a matrix form [p\c] using the Expert Profile Generator and Input Matricizer at step 364;
convert the matrix form resulting from step 364 into an embedded condensed vector [Vp\c] using the Input Vectorizer at step 366; and
use a distance or similarity calculation such as, but not limited to,

Euclidean distance or Cosine similarity, to compare (e.g., score) the similarity between the embedded vector [Vp] of the original input electronic document with the various embedded condensed vectors [Vp\c] of the chunks at step 368. This may involve collecting all embedded condensed vectors [Vp\c] of the chunks and normalizing which will cause the similarity score to be between 0.0 and 1.0.

At step 368, the chunks are ranked (e.g., sorted) based on the score from step 366 from high importance to low importance.

The sorted chunks with their similarity score can be utilized to understand how the PEA subsystem 44 perceives which portions of a given electronic paper document are more vital to its understanding and consequently where the emphasis is placed when searching the expert database for expert reviewers.

An example of the operation of the AI Explainer is now discussed with reference to Table 3. In this example, consider as input p=“After the military communications network is attacked by the enemy, in order to ensure that the information flow in the command and control organization can continue to be transmitted smoothly, the damaged network topology needs to be repaired in a timely and effective manner”. A chunker breaks the input into noun/verb phrases shown in section (a) of Table 3. The AI Explainer then compares an electronic paper document with missing chunks (shown in section (b) of Table 3) to the original electronic paper document p, via similarity scoring of their context vectors which is shown in section (c) of Table 3. In this example, based on the rankings resulting from the similarity score, the most important chunk for the understanding of the electronic paper document p is “damaged network topology” followed by “military communications network”.

TABLE 3
An example of the AI Explainer.

| | |
|---|---|
| (a) unranked chunks | (b) Chunk is removed from the original p. |
| | i.e.: p\chunk. |
| military communications network | After the |
| attacked | is attacked by the enemy, in |
| enemy | order to ensure that the information flow |
| ensure | in the command and control organization |
| information flow | can continue to be transmitted smoothly, |
| command and control | the damaged network topology needs to |
| organization | be repaired in a timely and effective |
| can continue to be transmitted | manner. |
| smoothly | |
| damaged network topology | |
| needs to be repaired | |
| timely and effective manner | |

(c) [p\chunk] compared to [p] for similarity score.
Repeat for each p\chunk and sort.
1.000 damaged network topology
0.997 military communications network
0.861 command and control organization
0.848 can continue to be transmitted
0.668 needs to be repaired
0.649 timely and effective manner
0.563 information flow
0.554 smoothly
0.481 enemy
0.428 ensure
0.399 attacked

Components of the BULK subsystem

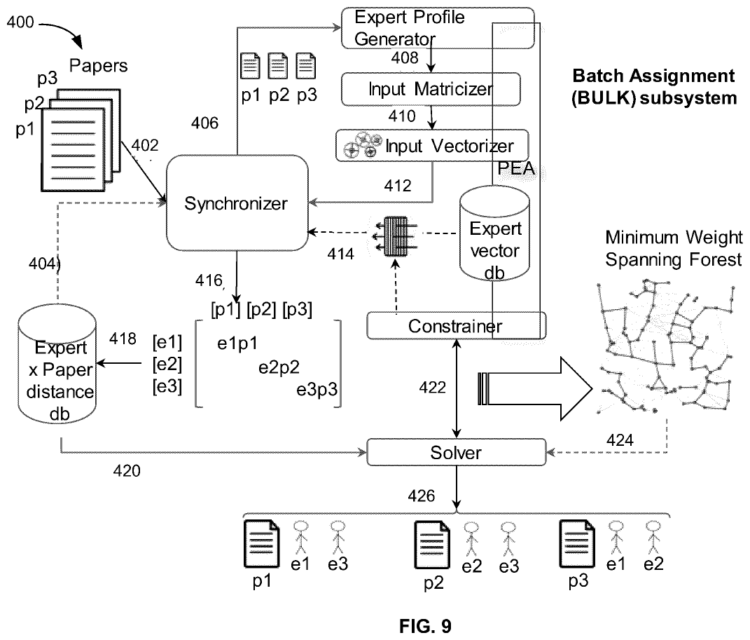

Referring now to FIG. 9, shown therein is a high level view of an example embodiment of block components and a method 400 that may be used by the BULK subsystem 46. The BULK function is to process a batch of electronic paper documents and assign the most suitable expert reviewers to individual electronic papers using the PEA subsystem 44 while honoring constraints such as, but not limited to, any combination of pool of available expert reviewers, expert reviewers subject matter preferences, expert reviewers minimum/maximum workload (i.e., number of reviews they are willing to do), number of reviewers to be assigned to each paper (quorum), and conflicts of interest avoidance, for example.

At step 402, multiple electronic paper documents are collected and supplied as a batch submission to the Synchronizer.

At step 404, for each individual electronic paper document of the batch of electronic paper documents, the Synchronizer checks a distance database to discover if this electronic paper document has already been processed. At step 406, those unseen electronic paper documents (i.e., not previously processed) are sent to the Expert Profile Generator.

At step 408, the Expert Profile Generator converts the unseen electronic paper documents into a raw text expert profile format that can be converted into matrix form.

At step 410, the Input Matricizer converts the expert profile raw text from step 408 into a matrix.

At step 412, the Input Vectorizer converts the matrices of step 410 into an embedded context vector.

At step 414, the expert vector database is searched for the top-k expert vectors for every paper vector obtained at step 412. The pool of available expert reviewers is (optionally) limited by the Constrainer, which may specify, among other constraints, who can volunteer to be a reviewer (this may be thought of as a filtering step).

At step 416, the cartesian product of the distances between all vectors of the electronic paper documents and the experts is created and stored in an expert x paper distance database at step 418.

At step 420, the Solver takes all the cartesian products that were determined at step 416 and constructs a minimum weight spanning tree at step 422 that is bound by conditions enforced by the Constrainer at step 424. Alternatively, a minimum weight spanning forest may be used.

At step 426, the tree of step 424 may be used to assign multiple expert reviewers to papers. This may be done by examining the final constructed forest where each edge of the graph represents an electronic paper that has been assigned to a specific expert for review.

One of the results of this process performed by the BULK subsystem 46 is that the electronic paper documents that are provided in a batch may be individually assigned to multiple experts for review such that each electronic paper is assigned to subject matter experts fluent with the technical/subject matter context of the electronic paper and any restrictions are satisfied by the Constrainer. Certain components of the BULK subsystem 46 are further discussed below.

### Constrainer

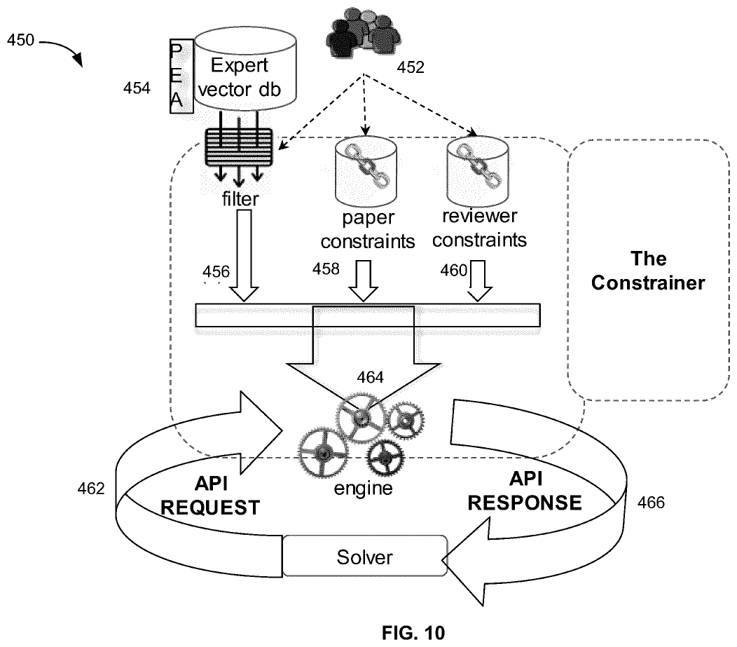

The Constrainer is a software program that may be used to manage bounds and constraints entered by the users or that were predefined such as by a system administrator. Batch assignment of electronic paper documents involves finding appropriate, including the best, subject matter expert(s) for each electronic paper while satisfying certain conditions. An example embodiment of a method 450 that may be used by the Constrainer is shown in FIG. 10.

At step 452, one or more users may input various assignment constraints.

For example, at step 456, the users may specify which experts the BULK subsystem 46 is allowed to consider as candidate reviewers. This is a subset of all of the experts that may be determined at step 454 by the PEA subsystem 44 and stored in the expert vector database. Accordingly, step 456 allows the users to specify a list of volunteer experts willing to participate as reviewers. It should be noted, that in at least one embodiment, this subset is optional. For example, the users may specify that all experts in the expert vector database are reviewer candidates.

As another example, at step 458, the users may specify paper constraints, which include, but are not limited to, how many reviewers should be assigned to each paper (i.e., quorum), individuals or affiliations that are in a conflict of interest, and which track a paper belongs to.

As another example, at step 460, the users may specify reviewer constraints which include, but are not limited to, minimum and maximum number of papers an expert is willing to review, and paper track preferences (if any).

At step 462, the Constrainer may then receive a request through its application programmer interface, also known as its API. Various actions may be performed depending on the nature of the API request, several example of which include:
if the API request is “POOL”, then the Constrainer may return the set of candidate experts specified in in embedded context vector form by performing steps 456, 464 and 466;
if the API request is “TRACKS#p”, then the Constrainer may return the set of tracks that a given electronic paper p belongs to as specified at step 458;
if the API request is “EXPERT#e”, then the Constrainer may return the set of preferred paper tracks of candidate expert e via steps 460, 464 and 466 (the Constrainer may have access to its own database for paper constraints and reviewer constraints);
if the API request is “QUORUM#p”, then the Constrainer may return the quorum number for electronic paper document p as specified in step 458;
if the API request is “MAX#e”, then the Constrainer may return the maximum number of electronic paper documents that expert e is willing to review as specified in step 460;
if the API request is “MIN#e”, then the Constrainer may return the minimum number of papers that expert e is willing to review as specified in step 460; and
if the API request is “CONFLICTS#p”, then the Constrainer may return a set of experts that may be considered to have conflicts of interests as specified in step 458. Conflicts can include, but are not limited to, authors of paper p, experts affiliated with the same institution as the authors of paper p, previous co-authorships on other papers, or similar past collaborations.

### Synchronizer

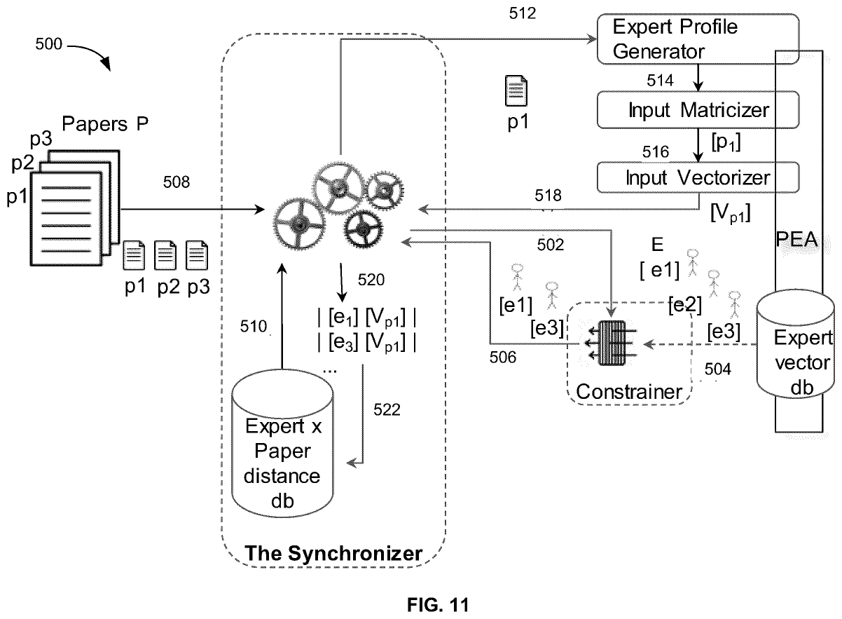

The Synchronizer is a software program that may use the embedded context vectors provided by the SM models to create a cartesian product of Euclidean distances of papers to experts. This product may be used by the Solver to find a near-optimal assignment of papers to reviewers. FIG. 11 shows an example embodiment of a method 500 as well as software components and data flow that may be used by the Synchronizer.

At step 502, the Constrainer may be called when there is an API request of “POOL” which may be used to return a set, denoted E, of candidate experts e1, e2, e3 (as a simple example) for reviewer assignment (e.g., via steps 504 and 506).

At step 508, a batch of electronic paper documents, denoted P, is submitted to the Synchronizer. For each individual paper pi, pi∈P, the Expert x Paper distance database may be checked at step 510 to see if electronic paper pi is already in the database. For example, if the electronic paper pi is p1 and the electronic paper p1 is NOT in the database, then the method 500 may involve:
sending the electronic paper p1 at step 512 for processing by the Expert Profile Generator at step 514, the Input Matricizer at step 516, and the Input Vectorizer at step 518 to create an embedded context vector [p1] for electronic paper p1 denoted [Vol]; and
for each individual expert candidate from, denoted e∈E:
   calculate the Distance between the expert vector [e] and the paper vector [Vp] at step 520 using distance measures such as the Euclidean Distance (which is preferable), the Cosine similarity, Jaacard correlation coefficients, Manhattan, or Minkowski distances; and
   save the calculated Euclidean distance in the Expert x Paper distance database at step 522.

### Solver

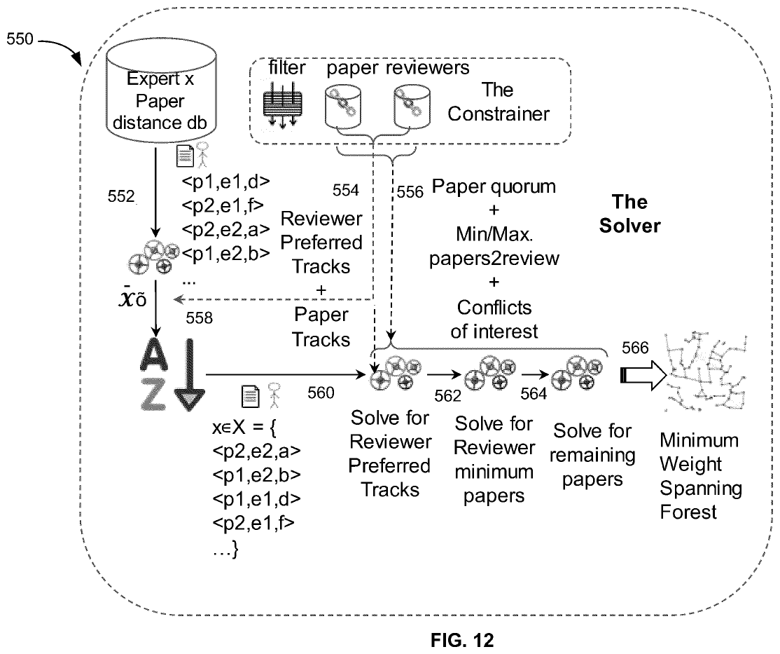

The Solver is a software program that may be used to compute a minimum weight spanning forest representing the solution for a near-optimal assignment of electronic paper documents to expert reviewers. FIG. 12 shows an example embodiment of a method 550 and the software components and data flow that may be used by the Solver.

At step 552, the set of tuples X from the Expert x Paper distance database is retrieved in the form x=<p,e,dist> where x∈X and dist is the Euclidean distance from paper p to expert candidate e. The Constrainer may then be called by using an API request of “POOL”.

The distance scores may then be adjusted for reviewer preferred tracks. This may be done by, for each distinct p of x=<p,?,?>, x∈X:
computing the standard deviation (std) for the Euclidean distance of all tuples X with electronic paper p;
For each x0, x0=<p,e,dist>, x0∈X:
   retrieving the set of tracks that electronic paper p belongs to, denoted Tp and call the Constrainer with the API request of “TRACKS#p”;
   retrieving the set of preferred tracks of expert e, denoted Te and call the Constrainer with the API request of “EXPERT#e”; and
   if any element of Tp is also in Te, i.e.: Tp∩Te≠∅, then the electronic paper p is in a track that expert e prefers and the Euclidean distance of tuple x0 may be adjusted by subtracting one standard deviation as computed above (i.e.: x0=<p,e,dist-std>) which will give a better chance of the electronic paper p being assigned to expert e.

At steps 556 and 558X may be sorted by low-to-high value of Euclidean distance. This may place the most relevant paper-to-reviewer assignment higher in the list.

The reviewers preferred tracks may be solved by the Solver. For example, the review preferred tracks and paper tracks are retrieved at step 554. Then the method 550 involves, for each p of x=<p,e,?>, x∈X:
if electronic paper p has already been assigned to expert e then skip this tuple x and go ahead three steps;
retrieve the set of authors (or other conflicts of interest) of paper p by calling the Constrainer at step 556 with an API request of “CONFLICTS#p”;
if the conflict of interest (e in the set from the previous step), then skip this tuple x and go to the next step;
retrieve the constraint paper quorum by calling the Constrainer at step 556 with an API request of “QUORUM#p”;
if paper quorum is reached, then skip this tuple x and go back to the first step;
retrieve the maximum number of papers that expert e is willing to review by calling the Constrainer at step 556 with an API request of “MAX#e”;
if expert e has already been assigned their maximum papers to review then skip this tuple x and go back to obtain another electronic paper p;
retrieve the set of tracks that paper p belongs to, denoted Tp by calling the Constrainer at step 556 with an API request of “TRACKS#p”;
retrieve the set of preferred tracks of expert e, denoted Te by calling the Constrainer at step 556 with an API request of “EXPERT#e”;
the track of paper p is not a preferred track for expert e (i.e.: Tp∩Te=∅) then skip this tuple x and go back to obtain another electronic paper p;
assign paper p to expert e for review at step 560 which may be done by adding a graph edge p-e at step 566; and
remove the tuple x from the set X.

The reviewers' minimum papers preference may be solved by the Solver. For example, for each p of x=<p,e,?>, x∈X:
if electronic paper p has already been assigned to expert e then skip this tuple x and go back to obtain another electronic paper p;
retrieve the set of authors (or other conflicts of interest) of paper p by calling the Constrainer with an API request of “CONFLICTS#p”;
if there is a conflict of interest (e in set from step 556) then skip this tuple x and go back to obtain another electronic paper p;
retrieve the constraint paper quorum by calling the Constrainer with an API request of “QUORUM#p”;
if paper quorum is reached then skip this tuple x and go back to obtain another electronic paper p;
retrieve the maximum number of papers that expert e is willing to review by calling the Constrainer with an API request of “MAX#e”;
if expert e already has assigned their maximum papers to review then skip this tuple x and go back to obtain another electronic paper p;
retrieve the minimum number of papers that expert e is willing to review by calling the Constrainer with an API request of “MIN#e”;
if expert e already has their minimum number then skip this tuple x and go back to obtain another electronic paper p;
assign paper p to expert e for review at step 564 and add a graph edge p-e at step 566; and
remove tuple x from set X.

The remaining papers in the set X may be solved by the Solver. For example, for each p of x=<p,e,?>, x∈X:
if paper p has already been assigned to expert e then skip this tuple x and go back to obtain another electronic paper p;
retrieve the set of authors (or other conflicts of interest) of paper p by calling the Constrainer with an API request of “CONFLICTS#p”,
if conflict of interest (e in set from step 556) then skip this tuple x and go back to obtain another electronic paper p;
retrieve constraint paper quorum by calling the Constrainer with an API request of “QUORUM#p”;
if paper quorum is reached then skip this tuple x and go back to obtain another electronic paper p;
retrieve the maximum number of papers that expert e is willing to review by calling the Constrainer with an API request of “MAX#e”;
if expert e already has assigned their maximum papers to review then skip this tuple x and go back to obtain another electronic paper p;
assign paper p to expert e for review at step 564 and add a graph edge p-e at step 566; and
remove tuple x from set X.

At the conclusion of method 550, the edges of the minimum weight spanning forest is the solution to the paper-to-expert reviewer assignment.

### EXAMPLES OF USE CASE SCENARIOS

Examples of various use cases for the teachings herein will now be discussed. It should be understood that the possible use cases are not limited to only the ones that are discussed herein.

### Case #1: Finding a Subject Matter Expert Qualified to Review a Paper.

Conference organizers and journal editors receive a large volume of papers either in a “batch” (e.g., for conferences) or in a steady stream of daily submissions (e.g., for journals). The papers must be favorably peer reviewed by multiple experts before the organizers/editors accept the submission. Below is an example output produced in accordance with the teachings herein using the abstract from the paper “UMLS to DBPedia link discovery through circular resolution”. The review committee can now examine the recommendations and request volunteer reviewers based on this output. If the committee is unsatisfied with these suggestions, the Expert Recommender may be used again to produce an alternative list (e.g., see the Expert Recommender, step 318:

serendipity loop in FIG. 6).

| Abstract from: | Recommended Experts (top-10): |
|---|---|
| Cuzzola, John & Bagheri, Ebrahim & | 1. Songmao Zhang |
| Jovanovic, Jelena. (2018). UMLS to | 2. Rafael S. Gonccedilalves |
| DBPedia link discovery through circular | 3. Jorge Gracia |
| resolution. Journal of the American | 4. Jonathan P. Bona |
| Medical Informatics Association: | 5. Dominique Ritze |
| JAMIA. 25. 10.1093/jamia/ocy021. | 6. Ernesto Jimnez-Ruiz |
| | 7. Martin Romacker |
| | 8. Gerhard Wohlgenannt |
| | 9. Veronique Malaise |
| | 10. Armando Stellato |

Case #2: Form a Cohort of People with the Same Interest and Experience.

A researcher may wish to create a team of collaborators to work on a specific project. The researcher may like to find people of equal experience as themselves and a few who have far more experience to act as project mentors. Example: John Cuzzola, who has 14 peer-reviewed publications, would like to build up a team consisting of four individuals with the same research interest and the same level of (publishing) experience. Additionally, he would also like to have two mentors who also share the same research interest but have considerably more publications. Below is the recommendation produced according to the teachings herein. For peers, the number of publications is similar to the target user ranging from 11-18 while the mentors have a substantially larger number from 64-226. All candidates have the same research interest as the profile that was used to initiate the search.

| | Recommended peers | Recommended Mentors |
|---|---|---|
| Profile used: | (top-10): | (top-10): |
| John Cuzzola | 1. Angel Luis Garrido (13) | 1. Achim Rettinger (82) |
| (14) | 2. Roman Prokofyev (10) | 2. Siegfried Handschuh (181) |
| | 3. Falk Brauer (15) | 3. Paul Buitelaar (142) |
| | 4. Kathrin Eichler (13) | 4. Haofen Wang (91) |
| | 5. Jan Dedek (11) | 5. Philipp Cimiano (194) |
| | 6. Angel L. Garrido (10) | 6. Jeff Heflin (64) |
| | 7. Peter Exner (13) | 7. Sophia Ananiadou (226) |
| | 8. Wenxiu Xie (11) | 8. Yuzhong Qu (122) |
| | 9. Rene Speck (18) | 9. Flavius Frasincar (185) |
| | 10. Wojciech M. Barczynski (12) | 10. Matteo Palmonari (92) |

### Case #3: Tenure Promotion.

Universities often operate based on a tenure-track hiring process where junior faculty members need to apply for tenure after a certain number of years by achieving high standard quality academic contributions. In many universities, the decision to grant a faculty member tenure is based on peer-review where already tenured faculty members with expertise in the same area as the candidate review the dossier of the candidate and make a recommendation. A system, utilizing the teachings herein, can take the dossier submitted by the candidate when applying for tenure and recommend the most appropriate reviewer who could provide feedback on the promotion application.

### Case #4: Grant Applications.

Funding agencies make decisions about whom to award funding based on collecting expert feedback on submitted funding proposals. Similar to a conference or journal review, funding applications are sent to several experts who comment on the merits or deficiencies of a proposed funding application. The funder may then consider the obtained assessments and make a decision as to whether a funding application should receive funding or not. The teachings herein may be used to recommend, based on the provided funding application, a group of experts who will be qualified to review and comment on the appropriateness and quality of the funding application.

In summary, in one aspect, in at least one embodiment described herein, a Portfolio Expert Alignment (PEA) subsystem is provided that comprises an Expert Profile Generator, a Vocabulary Builder, an Input

Matricizer, a Sequencer, SM models, an Input Vectorizer, an Expert Recommender with or without serendipity, and an AI Explainer that can collectively learn the specialty areas of an expert through analysis of the expert's electronic portfolio documents. Then, taking an electronic paper document as an input, the PEA subsystem may recommend suitable subject matter experts to review the input paper.

In at least one embodiment, a method is provided to implement the Expert Profile Generator for creating a subject matter expert profile from an expert's electronic portfolio documents where the subject matter expert profile is a block of text that summarizes the expert's contribution history.

In at least one embodiment, a method is provided to implement the Vocabulary Builder for learning an N-element floating point vector representation for every unique word obtained from the subject matter expert profile that is generated by the Expert Profile Generator.

In at least one embodiment, a method is provided to implement the Input Matricizerfor processing the natural language text output of the Expert Profile Generator and the unique word vectors of the Vocabulary Builder, to construct an M×N floating-point matrix representation of the text.

In at least one embodiment, a method is provided to implement the Sequencer for creating multiple deep learning models that can be used to compute subject matter similarity between two electronic paper documents, two electronic representations of the expert profiles for two experts or between an electronic paper document and an electronic representation of the expert profiles.

In at least one embodiment, a method is provided to perform learning-by-example by using an SM deep learning model that can construct an embedded context vector that embodies an expert's area of specialty, history, proficiency, and/or relevance to the state-of-the-art.

In at least one embodiment, a method is provided to implement the Input Vectorizer which may average the output of the SM models into a single embedded context vector that can be compared with other embedded context vectors for determining subject matter similarity.

In at least one embodiment, a method is provided to implement the Expert Recommender that can generate an embedded context vector through the use of the Expert Profile Generator, the Input Matricizer, and the Input Vectorizer, and can then retrieve the nearest top-k embedded context vectors stored in its experts database.

In at least one embodiment, a method is provided to implement a method for performing Serendipity that can be used to instruct the SM models to produce a different embedded context vector for the input supplied thus giving users the ability to ask for alternative suggestions for expert reviewers.

In at least one embodiment, a method is provided to implement the AI Explainer for providing insight as to why a set of experts were chosen as reviewers for a given electronic paper document.

In another aspect, in at least one embodiment described herein, a Batch Alignment (BULK) subsystem is provided that may utilize a Constrainer, a Synchronizer, and a Solver. The BULK subsystem may collectively optimize the assignment of a batch of electronic papers to multiple reviewers based on best reviewer suitability and individual paper and expert constraints.

In at least one embodiment, a method is provided to implement the Constrainer that provides limits to how papers can be assigned to reviewers by considering items such as quorum, expert preferences, and/or conflicts of interest.

In at least one embodiment, a method is provided to implement the Synchronizer which can produce a cartesian product representing the suitability of every expert to every paper.

In at least one embodiment, a method is provided to implement the Solver for constructing a minimum weight spanning forest that may represent a solution to the batch assignment of electronic paper documents to suitable expert reviewers.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

1. A computer implemented method for performing Portfolio Expert Alignment (PEA) for generating electronic profile data for expert reviewers and/or recommending one or more expert reviewers for reviewing one or more input electronic documents, wherein the method is performed by at least one processor and the method comprises:
receiving a plurality of electronic portfolio documents for each of the expert reviewers;
generating electronic expert reviewer profiles for the expert reviewers where the the electronic expert reviewer profiles are machine interpretable representations of the experts' portfolio based on the electronic portfolio documents;
receiving the one or more input electronic paper documents;
generating at least one electronic representation for at least one of the input electronic paper documents;
searching the electronic expert reviewer profiles to determine at least one match between the at least one electronic representation of the at least one input electronic paper document and one or more of the electronic expert reviewer profiles; and
generating a recommendation for one or more of the expert reviewers for reviewing the at least one input electronic paper document based on the at least one match,

2. The method of claim 1, wherein the method comprises using an Expert Pmfile Generator for creating the electronic expert reviewer profile from the electronic portfolio documents for the expert reviewer, where the electronic expert reviewer profile comprises a block of text that summarizes a contribution history for the expert reviewer.

3. The method of claim 2, wherein the method comprises using a Vocabulary Builder for generating an N-element floating point vector representation for every unique word vector obtained from the block of text.

4. The method of claim 3, wherein the method comprises using an input. Matricizer that processes the bock of text and the unique word vectors to construct an M×N floating-point matrix representation of the block of text.

5. The method of claim 1, wherein the method comprises using a Sequencer for creating multiple deep learning models that are used to compute subject matter similarity between two electronic paper documents, between two electronic expert reviewer profiles and/or between an electronic paper document and electronic expert reviewer profile.

6. The method of claim 5, wherein the method comprises using a Sequence Model (SM) deep learning model that generates an embedded context expert vector that embodies an expert reviewer's area of specialty, history, proficiency, and/or relevance to state-of-the-art.

7. The method of claim 6, wherein the method comprises using an input Vectorizer to average the output of the SM deep learning models into a single embedded context vector.

8. The method of claim 7, wherein the method comprises comparing the single embedded context vector with other embedded context vectors for determining subject matter similarity.

9. The method of claim 6, wherein the method comprises using Serendipity to cause the SM models to produce a different embedded context vector for the same input thus providing alternative recommendations for the expert reviewers.

10. The method of claim 1, wherein the method comprises using an Expert Recommender to generate an embedded context vector by using an Expert Profile Generator, an Input Matricizer, and an Input Vectorizer.

11. The method of'claim 10, wherein the method comprises using the Expert Recommender to retrieve nearest top-k embedded context vectors stored in an experts database.

12. The method of claim 1, wherein the method comprises using an AI Explainer software program which is adapted to provide to provide insight as to why a set of expert reviewers were recommended as reviewers for a given electronic paper document.

13. A computer implemented method for performing Batch Alignment (BULK) in which a plurality of electronic paper documents are assigned to a plurality of expert reviewers for review, wherein the method is performed by at least one processor and the method comprises:
receiving electronic representations of the plurality of electronic paper documents;
receiving electronic representations of the plurality of expert reviewers; and
optimizing an assignment of the plurality of electronic paper documents to multiple expert reviewers based on reviewer suitability and individual paper and expert constraints.

14. The method of claim 13, wherein the method comprises using a Constrainer that provides limits on assigning one or more expert reviewers or one or more electronic documents based on certain criteria for how the electronic paper documents are assigned to the expert reviewers.

15. . The method of claim 14, wherein the criteria include quorum, expert preferences, and/or conflicts of interest.

16. The method of claim 13, wherein the method comprises using a Synchronizer software program that is adapted to produce a cartesian product representing a suitability of a plurality of expert reviewers for reviewing a plurality of electronic paper documents.

17. The method of claim 13, wherein the method further comprises using a Solver to construct a minimum weight spanning forest that represents one solution of the batch assignment of electronic paper documents to suitable expert reviewers.

18. An electronic device for generating electronic profile data for expert reviewers and/or generating recommendations for one or more expert reviewers for performing a task, wherein the device comprises:
a memory unit storing program instructions for performing one or more functions related to generating the electronic profile data and/or generating the recommendations;
a processor unit that is coupled to the memory unit, the processor unit having one or more processors that, when executing the program instructions, are configured to perform a method that is defined according to claim 1.

19. A computer readable medium comprising a plurality of instructions that are executable on one or more processors of a device for configuring the one or more processors to perform a method that is defined according to claim 1.
